(19) United States
(12) Patent Application Publication
(10) Pub. No.: US 2005/0216586 A1
(43) Pub. Date: Sep. 29, 2005

(54) Website-controlled establishment of telephone connections

(75) Inventor: Michael Greve, Karlsruhe (DE)

Correspondence Address: DAVIDSON, DAVIDSON & KAPPEL, LLC, 485 SEVENTH AVENUE, 14TH FLOOR, NEW YORK, NY, 10018, US

(73) Assignee: WEB.DE AG, Karlsruhe (DE)

(21) Appl. No.: 10/514,253

(22) PCT Filed: Apr. 30, 2003
(86) PCT No.: PCT/EP03/04541

§ 371 Date: Oct. 29, 2004

Related U.S. Application Data
(63) Continuation of application No. 10/201,446, filed on Jul. 23, 2002.
(63) Continuation of application No. 10/354,709, filed on Jan. 29, 2003.
(60) Provisional application No. 60/457,888, filed on Mar. 25, 2003.

(30) Foreign Application Priority Data
Apr. 30, 2002 (EP) 02009777.0
Jul. 19, 2002 (EP) 02016141.0
Sep. 11, 2002 (EP) 02020333.7

(51) Int. Cl. G06F 15/173

(52) U.S. Cl. 709/225

(57) ABSTRACT

The invention relates a method for telephoning, wherein a telephone connection is established between at least two telephones under control of a web site.

### FIELD OF THE INVENTION

In general, the present invention relates to communications accomplished by using telephones. In particular, the present inventions relates to telephoning between at least two telephones, wherein the telephone connections used here are not established directly by a telephone but under control of a web site.

### BACKGROUND OF THE INVENTION

In order to communicate by using telephones via a telephone network, desired telephone connections are established starting from a telephone used to call to a telephone to be called. For that purpose, conventionally, a telephone number of the telephone to be called is transmitted by means of the calling telephone to a means of a telephone network used for establishing telephone connections. Here, a telephone connection is established from the calling telephone to the exchange means. On the basis of information obtained from the calling telephone, for example in form of the telephone number of the telephone to be called, the exchange means establishes a telephone connection to the calling telephone and connects these telephone connections or routes the telephone connections starting from the calling telephone to the exchange means to the telephone to be called.

This procedure has several drawbacks. On the one hand, conventional telephones are only capable to a limited extend to provide a user establishing a telephone connection with information of telephones to be called and persons to be called, respectively. There are telephones, which provide the user with stored telephone numbers. Such information about persons to be called and telephones, respectively, are of small content compared with information, which is available as regards persons and telephones, respectively, to be called. Further, the user friendliness of conventional telephones is primarily designed to establish a telephone connection between two telephones. The establishment of a conference call or a further telephone connection in addition to an already established telephone connection often requires complex operation procedures for the user of a telephone.

Moreover, it is not possible for a person who wants to call another person to indicate starting from which of his/her telephones a telephone connection should be established with the other person. Rather, a caller has to decide in advance which of his/her telephone he/she wants to use.

The document U.S. Pat. No. 6,337,858 B1 describes a method and an apparatus to permit voice communications between a consumer browsing the internet and a business having an interactive information page on the internet. The information page on the internet that the consumer is using in order to establish a telephone connection to the business belongs to said business.

Document U.S. Pat. No. 6,324,261 B1 describes a system for establishing a communications call between two parties with the help of a directory service provided on a worldwide web server. Here, the establishment of a telephone connection happens via the directory service, which can be a white page or yellow page service. The associated website does not belong to any of the parties but is owned by a third party being the directory service provider.

U.S. Pat. No. 6,282,281 B1 shows various methods of establishing telephone connections between a user A and a user B. In this context, user B may have a website with several web pages written in HTML and each page contains a graphical “phone” button. A whilst browsing B's website over the worldwide web may decide that he would like to call user B to discuss some items of interest. To call user B, A simply activates the phone button on the currently viewed page of B. A telephone connection may then be set up between the telephones of user A and user B with the help of the server associated to B's phone page. Thus, in the methods described by U.S. Pat. No. 6,282,281 B1, a telephone connection is established under the control of a website that belongs to the called party.

Accordingly, A has to separately go on each of the person's web pages that he wishes to call, in order to establish a telephone connection with them. If for example A wishes to call a different user after having called B using B's phone page, A first needs to leave B's phone page and then has to access the phone page of the other person that he wishes to call before he can actually initiate a telephone connection with this other person. If A wishes to call a great number of people, using the system described in U.S. Pat. No. 6,282,281 B1 can become very cumbersome.

Document Low C et al: “webin—an architecture for fast deployment of in-based personal services” Workshop record. Intelligent Network. Freedom and Flexibility: Realising the promise of intelligent Network services, XX, XX, 21 Apr. 1996 (1996-04-21), pages 1-12, XP002043670 describes a system analogous to the one described in U.S. Pat. No. 6,282,281 B1.

### OBJECT OF THE INVENTION

Following from the problems mentioned above it is an object of the present invention to provide a method for setting up telephone connections using a webpage, which method allows a user wishing to set up more than one telephone connection to do so in a simple way with a minimum of effort.

### SHORT DESCRIPTION OF THE INVENTION

The approach underlying the present invention to solve the above object is to establish a desired telephone connection under control of a web site. The present invention contemplates that for establishment of a telephone connection from a telephone to at least one other telephone a web site is used, which is associated to the person requesting the desired telephone connection. In contrast to the state of the art, therefore, establishing a telephone connection according to the invention does not necessitate the use of the telephone of the person (also referred to as “caller” in the following) initiating the desired telephone connection. Rather, the caller uses his/her web site in order to define the telephone or the person to be called, whereby the input of a telephone number in a telephone as conventionally required is avoided. Due to the property of a web site to provide practically unlimited information and interactive operation capabilities, the user friendliness and user support in establishing telephone connections can be improved.

Particularly, the present invention provides a method for telephoning wherein a telephone connection between at least two telephones is established under control of a web site.

The term “web site” as used herein defines sites and sub-sites associated thereto, which can be uniquely addressed by means of a single address such as a telephone number, an IP address, an URL, etc. In particular, the term “web site” defines a web site known from the Internet with a specific URL, which can be used by means of suitable data transmissions and connections using the Internet.

Further, a web site in terms of this invention can comprise one or more web pages. Web pages represent a part of a web site.

Preferably, a telecommunications web site is used in the method according to the invention. A telecommunications web site differs from conventional web sites in that they provide, upon an access of an end user, direct private communication for the accessing end user.

A telecommunications web site is associated to, personalized for or corresponds with a specific person. In this context, the term “person” is used to represent any entity capable of communicating with a web site. Examples are, besides natural persons, companies, single units, for example in form of technical arrangements or systems and in form of software applications, specific addresses, specific geographic locations, specific end user devices and the like. As end user devices in this invention, end user devices are contemplated, which can access a web site via a data network, in particular via the Internet. Examples comprise computer-based systems, personal computers, portable and mobile computer units, WAP-capable means and devices and the like.

A further feature of a web site according to the invention, in particular of a communications web site according to the invention, is that this is not limited to a single transmission medium in contrast to a web site known from the Internet. Rather, a web site according to the invention allows a so-called multi-media communication, and i.e., for example, the Internet, telephone networks, IP-based networks, GSM networks, UMTS networks and the like can be used. This allows to establish telephone connections between telephones by means of a web site according to the invention.

Preferably, in establishing a telephone connection according to the present invention, a telephone connection is established via a conventional telephone network, wherein a single or more telephone connections required for establishment of a requested telephone connection are established under control of the web site.

It is possible that, as both the caller and the person to be called use telephones as end user units, the telecommunications web site works as a virtual operator connecting both the calling party and the called party.

Several types of telephone connections can be used to establish a communications link between the telephones. Preferably, a telephone connection is established according to the most effective path. Most effective preferably means the path with the highest quality of service. It may also mean the path with the lowest cost or billing structure, or a combination of these criteria.

Further, it is preferred that the telecommunications web site includes a connection means for establishing a communications link (telephone connection) between at least two telephones. With this combination of a telecommunications web site with a connection means, it is also possible to connect different telephones from different technical environments to each other.

The connection means may be controlled by the telecommunications web site. By controlling the connection means by the telecommunications web site, the telecommunications web site can work as a “virtual operator”. The telecommunications web site can now connect two or more telephones by controlling the connection means that are used to establish this specific telephone connection between these telephones. This telephones connection is established and/or provided by the telecommunications web site, not necessarily via the telecommunications web site.

The connection means may be a converter, an adapter, an IP-switch, an ATM-switch, a mechanical or electro-mechanical switching board, a protocol translator, a gateway, especially a telephone network gateway, a UMTS/G3 network gateway, a computer network gateway, a television network gateway, a cable network gateway and/or an Internet gateway or a combination of these components. With these components, the telecommunications web site may establish a telephone connection between the specific telephones building up chains of components to establish this connection. Preferably, these chains of components also comprise transport means like cable, wire, networks, radio communications, etc.

Here, it is contemplated that the caller provides his/her web site data, which characterize the person or the telephone to which the caller requests a telephone connection. In contrast to the state of the art, the use of a telephone is not required here.

On the basis of the information provided by the caller as regards a person to be called and a telephone to be called, respectively, the web site can first establish a telephone connection to a telephone of the caller. This makes it possible that the caller is not required to decide which of his/her telephones should be used when defining a person to be called or a telephone to be called.

Rather, the use of a web site allows the caller, essentially independent of a point of time when he/she provides information characterizing the person to be called or telephone to be called, to decide by means of which telephone he/she wants to telephone. Further, the use of a web site allows that the caller can, by means of his/her web site, establish a further telephone connection in addition to a telephone connection already existing, wherein he/she is not limited in his/her selection to which of his/her telephones the further telephone connection is to be established.

After the establishment of a telephone connection to one of his/her telephones, which the caller has preferably defined by respective information provided to the web site, the web site can establish a telephone connection to the telephone defined by the caller or to the person defined by the caller. Preferably, this telephone connection is established as early as the caller has controlled or operates the telephone indicated by him/her such that the web site is informed that the caller actually wants to establish the requested telephone connection. For example, this can be accomplished in that the caller, in response to the telephone connection established to his/her telephone by the web site, activates that telephone for telephoning, i.e. for example lifts the telephone hand set.

As an alternative, it is possible that the web site first establishes a telephone connection to the person desired by the caller or to the telephone desired by the caller, and subsequently provides for a telephone connection to a telephone defined by the caller when the desired person and the desired telephone, respectively, can be actually contacted, i.e. a telephone connection established thereto is existing. Again, it remains the caller's option to define which of his/her telephones should be used.

Depending on the way in which the web site establishes telephone connections, these will be, if actually existing, connected such that the caller can telephone with the person to be called and the telephone to be called, respectively, in the conventional manner. As an alternative to a connection of telephone connections, the web site can forward a telephone connection being established first, i.e. can forward the telephone connection established with the used telephone of the caller to the person to be called and the telephone to be called, respectively, or can forward the telephone connection to the person to be called and the telephone to be called, respectively, to the telephone of the user to be used.

Further, it is contemplated that telephone connections established by means of the web site can be controlled. In particular, the web site should allow that, in response to a respective input from the caller's side, an established telephone connection is maintained and/or muted.

This makes it possible, using the web site, to establish a further telephone connection besides an existing telephone connection to a different telephone to be called or to a different person to be called without being required to terminate the existing telephone connection.

It is also possible to establish a telephone conference with at least two persons to be called or two telephones to be called, respectively, using the web site and under control of the same.

Here, it is contemplated that, even in case of an existing telephone conference, besides the same one or more telephone connections can be established which will not form part of the telephone conference.

Preferably, the web site is adapted such that each single condition and step, respectively, in establishing a telephone connection is indicated to the caller. For this purpose, for example, different web pages, windows, text displays, colour designs, voice outputs, audio outputs and the like may be used, which can support the interactivity in using the web site.

Thus, the present invention provides a method for telephoning, wherein information is provided from a caller to a web site, which characterizes a first telephone to be called. Then, by means of this information, a first telephone connection to the first telephone to be called is established under control of the web site.

Preferably, the first telephone connection is established under control of the web site between the first telephone to be called and a first telephone indicated by the caller.

Here, it is contemplated that information characterizing the first telephone of the caller is provided to the web site by the caller.

For establishing the first telephone connection it is possible that the web site first establishes a telephone connection to the first telephone of the caller and subsequently establishes a telephone connection to the first telephone to be called. In order to put the requested telephone connection into operation, these telephone connections are connected under control of the web site.

Advantageously, in this case, the telephone connection to the first telephone to be called is established only when the caller indicates, for example by lifting the telephone hand set of his/her indicated first telephone, that he/she actually requests the first telephone connection.

As an alternative, it is possible that the web site first establishes a telephone connection to the first telephone to be called and subsequently establishes a telephone connection to the first telephone of the caller, which is to be connected therewith.

Here, it is contemplated that the telephone connection to the first telephone of the caller is established only when the telephone connection intended for the first telephone to be called was actually established.

Further, it is possible to establish a second telephone connection to a second telephone to be called under control of the web site, wherein information characterizing the second telephone to be called is provided to the web site by the caller.

Here, it is possible, under control of the web site, to establish the second telephone connection between the second telephone to be called either to the first telephone of the caller or to another, second telephone defined by the caller. Here, it is also possible that the caller provides the web site with the information characterizing the second telephone of the caller.

The establishment of the second telephone connection can, as set forth above with reference to the first telephone connection, be first established to the first telephone or to the second telephone of the caller and then to the second telephone to be called or to this first and then to the first or second telephone of the caller.

The observations made with respect to the second telephone connection correspondingly apply to a third and each further telephone connection to a third party to be called and further telephones to be called as well as to third and further telephones of the caller.

Telephone connections established under control of the web site can be maintained in parallel, wherein users of telephones that were called can only communicate with the caller. In that case, only one telephone of the caller is used and telephone connections to the called telephones currently not used for communication can be muted or maintained. When using two or more telephones of the caller it is possible that the caller communicates with several telephones to be called in parallel.

Further, it is possible that, under control of the web site, telephone connections being subsequently or simultaneously established can be integrated or united in a telephone conference, wherein telephones to be called participating in the telephone conference can simultaneously communicate with the caller. Here, it is contemplated that telephone connections united in a telephone conference can be established and maintained, respectively, in parallel to telephone connections being separated therefrom. This makes it possible that the caller is enabled to communicate on the one hand in a telephone conference, and separately, by means of at least one telephone connection.

Preferably, the web site displays to the caller the operation conditions occurring for establishment or during establishment of telephone connections of both the web site itself and as regards telephone connections to be established and/or to be maintained under control of the web site. This can be accomplished by means of graphical displays (web pages, windows, menus, icons, control fields, control areas, buttons) and the like, acoustically (e.g. voice outputs, audio outputs) and the like.

In order to provide the web site information of the above named kind from the caller's side, it may be necessary that the caller accesses the web site. Here, for security purposes, it can be necessary, that the caller provides identifying data, for example in form of passwords, ID codes and the like.

Further, it is contemplated that the establishment and/or the maintenance and/or the termination of a telephone connection being established under control of the web site is accomplished by means of the web site in response to information provided by the caller. Here, it is possible that the caller provides information to the web site which indicates that a telephone connection is to be established, that a telephone connection is to be muted, that a telephone connection is to be integrated in a telephone conference, that a telephone connection is to be removed from a telephone conference or that a telephone connection is to be terminated.

Preferably, the user employs an end-user device, which is no telephone of the caller, for providing information and/or for accessing the web site. In particular, it is contemplated that the caller uses a computer-based system, for example a personal computer and the like.

In a particularly preferred embodiment of the method according to the invention, a telecommunication web site is used as web site.

### SHORT DESCRIPTION OF THE FIGURES

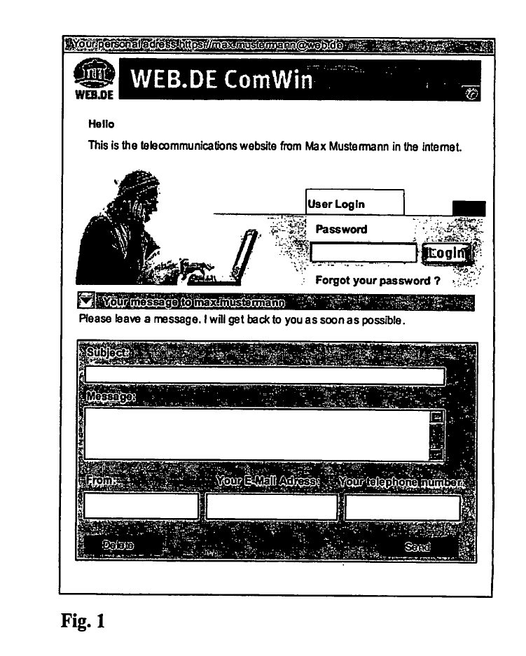

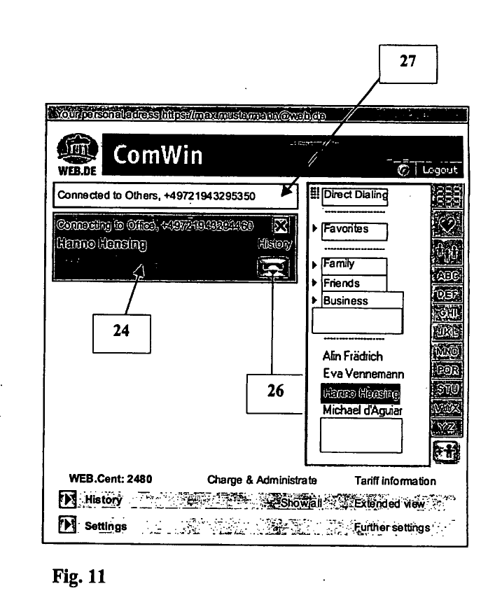

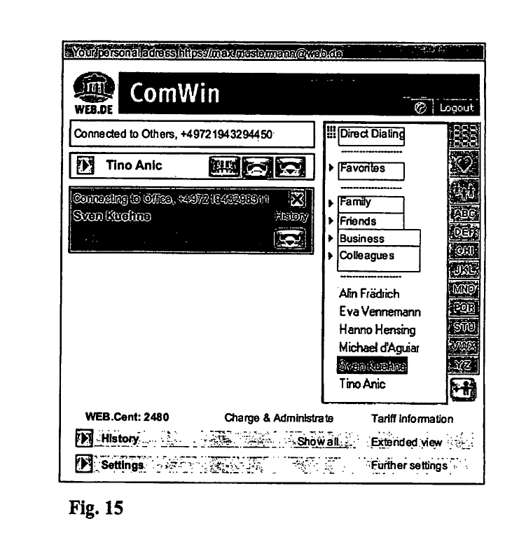

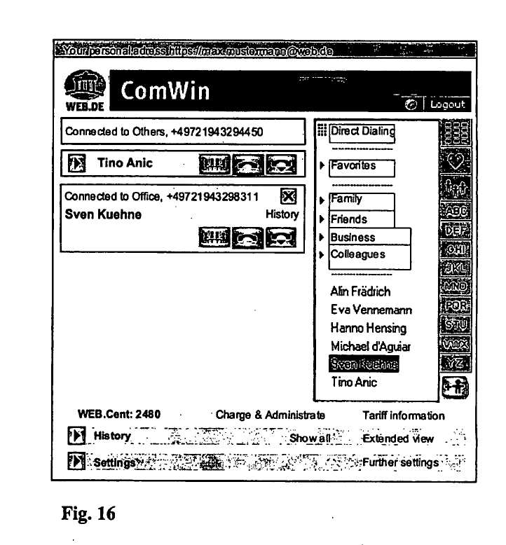

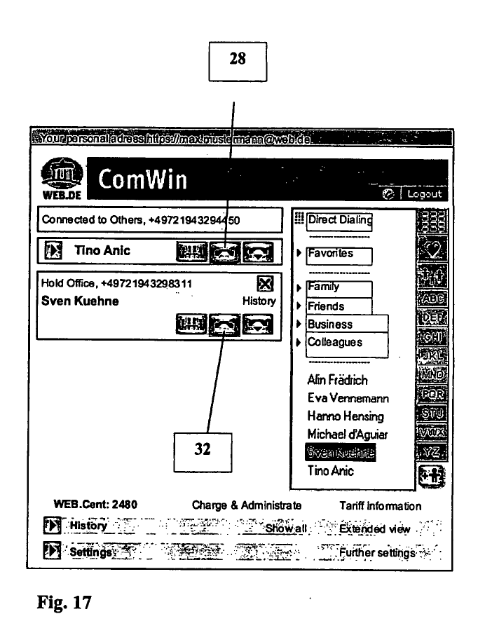

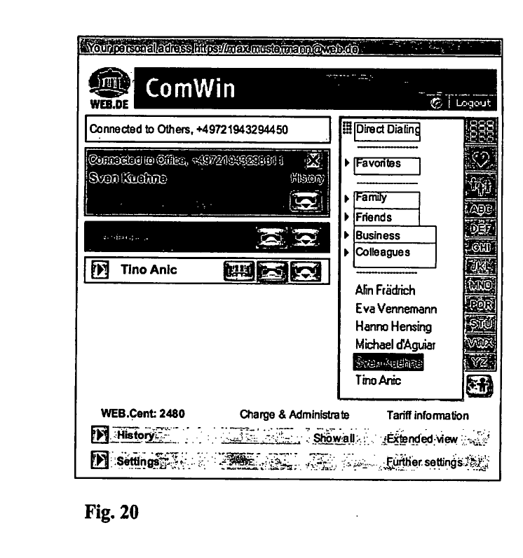

In the following description of preferred embodiments, it is referred to the enclosed FIGS. 1 to 23, which illustrate web pages according to the invention of a web site according to the invention.

### DESCRIPTION OF PREFERRED EMBODIMENTS

The following description is based on a scenario, wherein a user of a telephone, which will be referred to as caller and calling telephone, respectively, wants to establish a telephone connection to another user of another telephone, which will be referred to as called person and called telephone, respectively, in the following using his/her telecommunications web site, i. e. of the caller.

In order to put the requested telephone connection in operation by means of his/her telecommunications web site, the caller contacts his/her communications web site. This is accomplished in that the caller utilizes a browser (software application for Internet based communication) executed on a computer system (e.g. personal computer) used by him/her for inputting an identification or address uniquely identifying his/her telecommunications web sites, for example in form of an URL.

This effects that the caller gets to a web page of his/her telecommunications web site illustrated in FIG. 1. As all other web pages of the telecommunications web site of the caller, this web page is personalized for him/her. In that case, personal invention is indicated by means of the name (“Max Mustermann”) of the caller inserted in this web page on suitable locations. Further possibilities to personalize a web page of the telecommunications web site of the caller is an integration of data being uniquely associated to the user and uniquely characterizing the same, respectively, for example in form of initials, telephone numbers, E-mail addresses and the like. In contrast to other web pages of the telecommunications web site of the caller, the web page shown in FIG. 1, which also can be referred to as start page, is accessible to the public. That is, any person knowing the address and identification, respectively, of this telecommunications web site can get to this web page.

As explained in the following, further access to other web pages of the telecommunications web site of the caller is not possible for other persons. However, a person being different from the caller can use the web page “start page” to provide a message to the caller as “owner” of this telecommunications web site.

For that purpose, the portions/windows illustrated in the lower portion of FIG. 1 are contemplated. By means of these it is possible to provide the owner of this telecommunications web site, i.e. the caller, a message for example in form of an E-mail or an SMS.

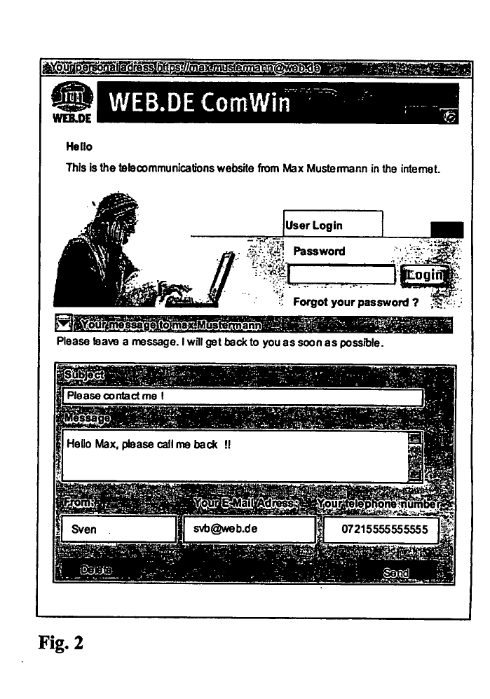

In FIG. 2, the web page is illustrated subsequently to a use of the named portions/windows. In the text field provided with the designation “Message:” in FIG. 2, a text to be sent as E-mail is inputted. In the text field provided with the designation “From:” in FIG. 2, the person utilizing this type of communication has inputted his/her name, his/her initials or other characterizing information. In order to enable the owner of the telecommunications web site to re-transmit a message in form of an E-mail and/or by means of a telephone call, it is possible to input an E-mail-address requested for receipt of an answer into the text field provided with the designation “Your E-mail-address:” and a telephone number, respectively, requested for an answering call into the text fields provided with the designation “Your telephone number:”. An operation of the control field “Send” effects a transmission the E-mail.

Beyond that, for persons, whom do not correspond with the caller being owner of the telecommunications web site comprising the web page illustrated in FIG. 1, it is not possible to utilize this telecommunications web site, i.e. to get to web pages being different to that illustrated in fig.

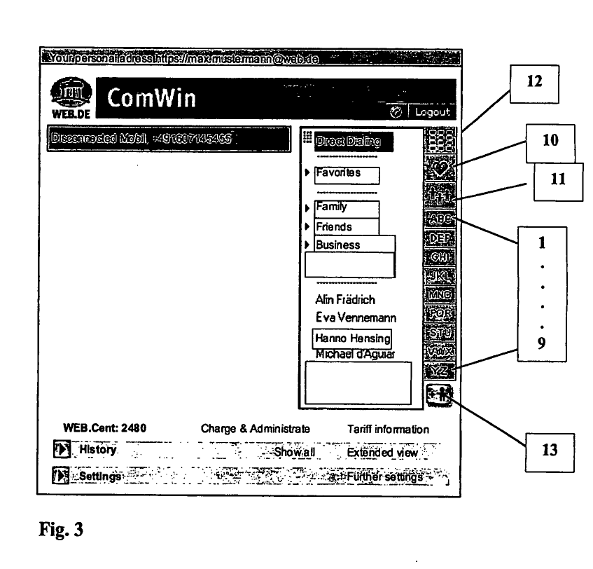

For further utilization of the telecommunications web site it is necessary to input a password, a code, a key or comparable into the text field named with the designation “Password”. In order to enhance security, it is further contemplated that further data for identification of the telecommunications web site must be provided, for example, in form of biometrical data (e.g. speech, finger prints, prints of the anterior of an eye and the like). In order to support the owner of the telecommunications web site, i.e. the caller, his/her name (“Max Mustermann”) is already entered in the web page. If the password is correctly inputted, it is possible to access and use, respectively, further pages of the telecommunications web site. For that purpose, subsequent to an input of a password, the switching field “Login” is activated. In case, this procedure referred to as “registration” is successfully completed, i.e. if both username and password are correct, the caller gets to the web page illustrated in FIG. 3.

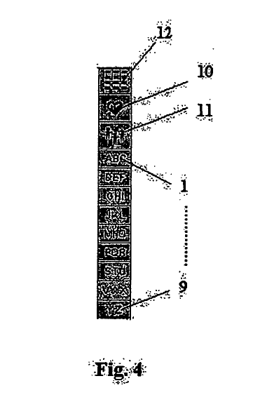

The web page illustrated in FIG. 3 enables the caller to accomplish and initialize, respectively, different interactive procedures. By means of the menu bar illustrated in FIG. 3 at the right and in FIG. 4 in separated, enlarged manner, different control fields are provided. These control fields altogether serve for management and utilization of address entries of the caller. Here, address entries are to be understood as such data/or information, which characterize persons, telephone connections, computer units and systems, respectively, and the like that can be connected using the telecommunications web site.

Such address entries are sorted in alphabetical manner, wherein it is possible to access the same activation of the control fields 1, . . . . , 9 (“abc”, . . . . , “yz”). Further it is possible to associate address entries to a group referred to as “Favorites”, in which address entries often used are integrated. By activation of the control field 10 the caller directly gets to address entries of the group “Favorites”. Address entries can be also grouped according to different criteria, such as family, friends, business contacts, colleagues and the like. Accesses to such grouped address entries are accomplished by operation of the control field 11.

In order to enable the caller to also telephone with persons for which no address entry is existing the control field 12 is provided. A selection of this control field routes the caller to a web page not illustrated here where he/she can directly input a telephone number to be called.

In order to include a new address and tree, the caller operates the control field indicated with 13 in FIG. 3 and 4.

In order to modify or to utilize existing address entries, the caller selects, as indicated by means of the name “Hanno

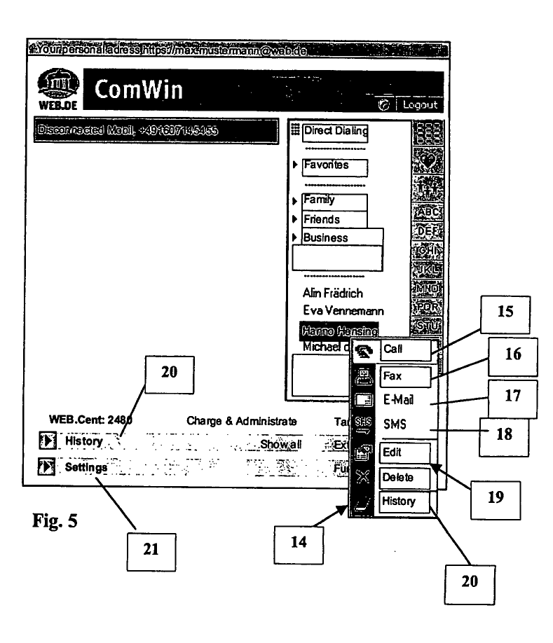

Hensing” being shaded in FIG. 5, a desired address entry. An address entry thus selected can be used comparable to a control field. Here, it is contemplated that a utilization of a selected address entry as control field is possible by operation of the right button of a mouse having two buttons (left mouse button in a mouse used by a left-handed person). The utilization of a selected address entry comparable to a control field can also be effected in different manner, for example by means of a given key combination of a keyboard of a computer used by the caller.

When the caller has chosen the selected address entry and has activated the same comparable to a control field, he/she is presented the window indicated with reference numeral 14 in FIG. 5. In this window 14, further control fields are provided, which enable the caller to call the person associated to a selected address entry or to provide this a person a facsimile, an E-mail or an SMS-Message. These control fields are indicated by the reference numerals 15, . . . , 18 in FIG. 5.

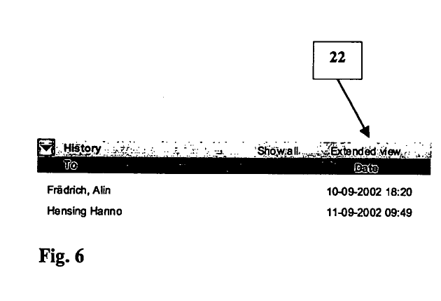

By means of the control field “Edit” in the portion indicated by 19 the caller can modify (edit) the selected address entry, while the control field “Delete” effect that the selected address entry is removed from the address entries of the caller. In case, the caller selects the control field 20, he/she is provided, as illustrated in FIG. 6, a view concerning the manner he/she has communicated with the person associated to the selected address entry. In the example illustrated in FIG. 6, all the telephone connections to the person of the selected address entry are listed. As an alternative, it is contemplated that this list referred to by the term “History” presents different communications types, also in combination with each other and also in combination with the telephone calls carried out.

The presentation of the history of communications connections with the person associated to the selected address entry can be accomplished in form of a window in the web page illustrated in FIG. 5 or in an own web page not being illustrated here. In the illustrated example, the presentation “History” will be presented in a window integrated in the page of FIG. 5. By operation of the control field “Extended view” indicated by 22 in FIG. 6, the caller is provided a list of accomplished communication concerning the selected address entry in a new web page.

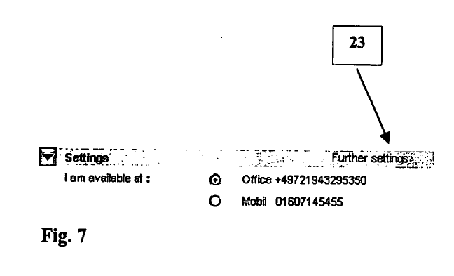

In case the caller selects the control field “Settings” indicated by 21 in FIG. 5, he/she gets to the presentation illustrated in FIG. 7. This presentation indicates under which telephone number the caller can be currently contacted at that time. Further, it is possible to modify the set telephone number in a window provided in the web page illustrated in FIG. 5 or in a presentation displayed in an own web page. In the illustrated example, the caller can select between his/her private telephone number (“mobile”) or his/her business telephone number (“office”).

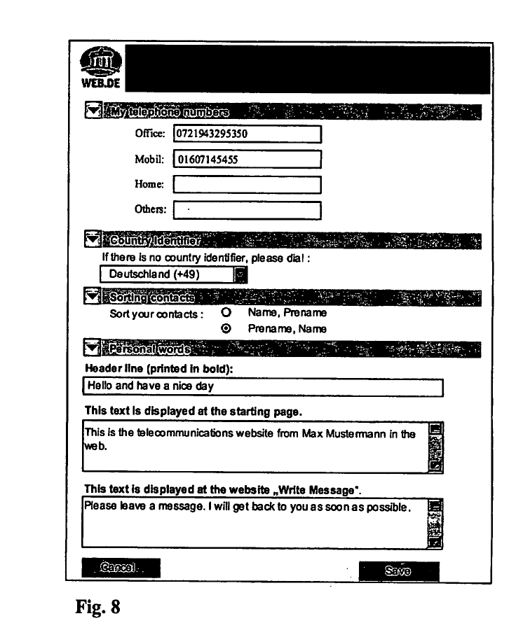

In case the caller operates the control field “Further settings” indicated by 23 in FIG. 7, he/she gets to the web page illustrated in FIG. 8. As can be seen there, by means of that web page, the caller is enabled to accomplish and modify, respectively, his/her personal settings in his/her telecommunications web site as regards its utilisation for telephone connections. As set forth in the beginning, the telecommunications web site described here represents a specific communications web site referred to as “WEB.DE ComWin” (private telephone exchange). As an alternative, its function as private telephone exchange can also be provided by a telecommunications web site associated to the caller, which provides different functions in addition. In this case, the telecommunications web site described here would represent a sub-web site or a group of web pages of such a telecommunications web site contemplated for several functions.

The telecommunications web site as described here serves as telephone exchange (“ComWin”) in order to establish a telephone connection between a telephone of the caller defined according the settings (see FIGS. 7 and 8) and another telephone of a person (“called person”) being selected using address entries (see FIG. 5), with whom the caller wants to telephone. A fundamental difference to a telephone connection being conventionally established, i.e. in response to the input of a telephone number in a telephone, here, the caller does not use his/her telephone for inputting a requested target telephone number.

Also, the establishment of a requested telephone connection is different compared to the establishment of a conventional telephone connection. In case, the caller has selected the telephone number of the person to be called, first a telephone connection to the telephone of the caller defined in the settings is established under control of the telecommunications web site of the caller. Only when the caller actually wants to establish the requested telephone connection to the person to be called, a telephone connection to the telephone of the person to be called is established under control of the telecommunications web site. The fact that the caller actually wants to set up the requested telephone connection, can be recognised by the telecommunications web site in that, for example, the caller picks up, in response to the establishment of a telephone connection to his/her telephone, the handset thereof or indicates in a different manner that he/she wants to take the call. Here, it is possible to indicate the telephone connection established by means of the telecommunications web site to the telephone of the caller comparable to a conventional telephone call, for example, in that the telephone of the caller rings.

For establishment of these telephone connections, it is contemplated that the telecommunications web site establishes two, initially separated telephone connections, namely one to the telephone of the caller and one to the telephone of the called person, which are subsequently connected with each other. As an alternative, it is possible that the telecommunications web site initially establishes the telephone connection to the telephone of the caller and, then, roots the same in direction to the telephone of the called person if actually requested by the caller.

In order to indicate which person should be called, the caller can precede in different manner. The caller can, after activation of control field 12 (see FIG. 3), manually input a desired telephone number. Further, the caller is allowed, as set forth with reference to FIG. 5, to select a telephone number being associated to a selected address entry by operation of control field 15. A faster method to select a telephone number being associated to an address entry is to activate a displayed address entry comparable to a control field. This can, for example, be accomplished by an operation of a mouse referred to as “double-click”.

In the following, the further course is explained by means of example of a selection of a telephone number for an existing address entry. These observations correspondingly apply for a telephone number entered by manual input, wherein due to a missing associated address entry information available by means of the same are not provided to the caller as long as single or more of such information, which relate to a telephone number to be called and a person associated to the same, respectively, can be provided in different manner (e.g. by access to a database from the telecommunications web site's side in dependence of a manually inputted telephone number).

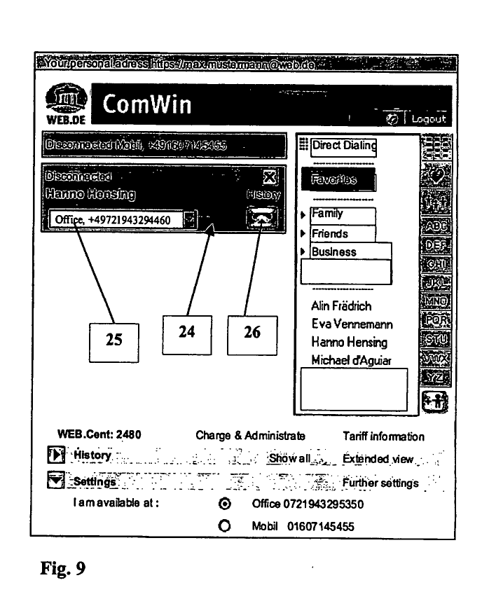

In case the caller has selected a telephone number to be called using an address entry, he/she is displayed the web page illustrated in FIG. 9. In this web page, the caller is still allowed to modify the telephone number under which a telephone connection should be established (see FIG. 9 bottom). The presentations of FIGS. 5 and 9 differ essentially by the “Contact” window 24 illustrated in FIG. 9. Accordingly, it is possible that, in place of an own web page, the web page illustrated in FIG. 5 is used and is amended by contact window 24.

The name of the person to be called as well as the telephone number to which a telephone connection is to be established is presented in the contact window. In the illustrated example, the caller has entered that he/she wants to establish a telephone connection to the office (“Office”) of the person to be called (“Hanno Hensing”). The telephone number to be called can be modified by operation of the control field 25.

Further, the current condition as regards a telephone connection to the person to be called is presented in window 24. The graphical design of a control field 26 in FIG. 9 (“telephone handset not putted down”) indicates that presently no telephone connection is established. The arrow of control field 26 pointing upwards indicates to the user that an operation of the control field 26 effects that a telephone connection to the desired person is established. In order to support the user guidance provided by the control field 26, the control field 26 can be colourwisely designed in suitable manner, for example green.

When the user activates the control field 26, the telecommunications web site starts, as set forth above, to establish a telephone connection to the person to be called.

Here, the appearance of the window 24 is modified such that the field indicated by 25 in FIG. 9 is not displayed any more. Due to the procedure for establishing a telephone connection to the person to be called to initially call the caller, it is contemplated that the contact window changes its colour, for example obtains an orange colouring.

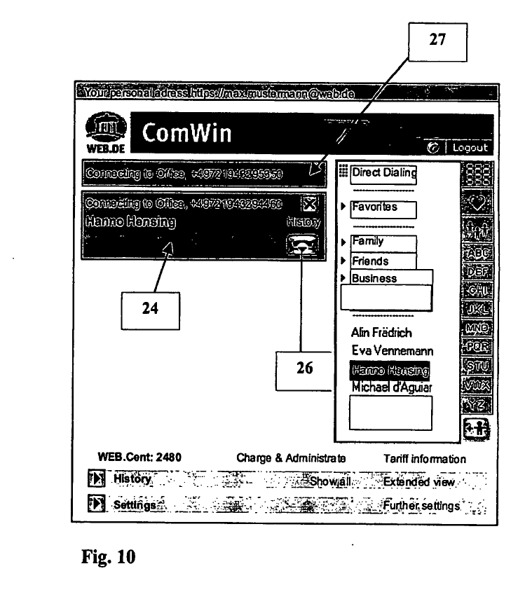

Further, it is possible to indicate this condition by means of a “statusn” window indicated by 27 in FIG. 10. In this window, that condition can be made clear by means of a suitable text (“connected . . . [naming the telephone number of the caller telephone]”) and/or by means of a suitable colouring (advantageously in the same colour as window 24 in that condition, i. e. orange).

Further, the appearance of the control field 26 has changed such that it now comprises an arrow pointing downwards. This indicates that an operation of the control field 26 initialises a termination of the telephone connection to the given telephone of the caller initialised by the telecommunications web site. This can additionally be supported in visual manner in that the control field 26 is suitably coloured, e. g. red. This effect of an operation of the control field 26 also applies to the following, wherein there in dependence of the respective condition regarding single or several telephone connections the respectively established telephone connection (s) is (are) terminated from the telecommunications web site's side.

In case the caller has picked up the telephone handset of his/her telephone and thereby has informed the telecommunications web site that he/she actually wants to carry out that requested telephone connection, this condition is indicated to the caller by means of the status window 27.

In the illustrated example, this is accomplished by the presentation of a corresponding text (“Connected . . . [naming the telephone number of the caller telephone]”) advantageously in combination with a corresponding colourwise design of the status window, for example in green. Because no actual telephone connection to the person to be called is existing at that point of time, the presentation of the contact window does not change, i. e. the exemplary orange colouring is maintained.

In response to the indication of the caller to actually establish the requested telephone connection, now, under control of the telecommunications web site, a telephone connection to the telephone to be called is established. This condition is indicated to the caller by means of window 27, for example by means of a suitable text presentation (“connected . . . [naming the telephone number of the caller telephone]”) and/or a suitable colouring (for example orange for conditions wherein telephone connections are initiated by the telecommunications web site).

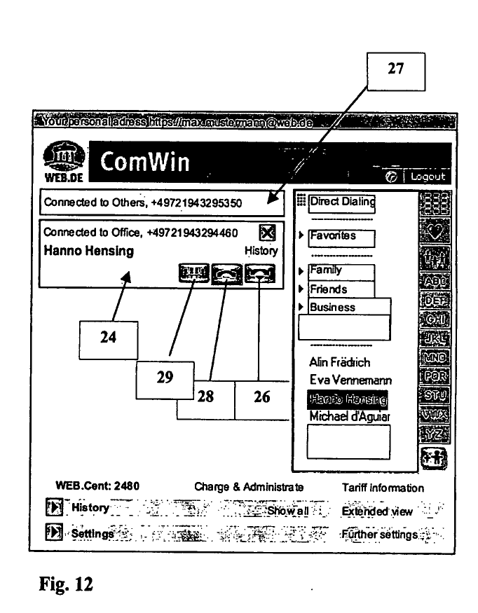

In case, a telephone connection between the telephone of the caller and the telephone of the person to be called is successfully established, i. e. the called person has picked up the telephone handset of his/her telephone, this condition is indicated by means of the contact window 24 and the status window 27. For that purpose, the status window can display a suitable text (“Connected . . . [naming the telephone number of the caller telephone]”) and/or can exhibit a suitable colouring (e. g. green). Also, the contact window 24 can change its colour accordingly, e.g. can be green. Further, the caller recognises this condition, i. e. the successful establishment of a telephone connection to the telephone of the person to be called, by means of the control fields 28 and 29 included in the contact window 24. This is illustrated in FIG. 12.

In order to terminate the telephone connection with the person to be called, the caller operates control field 26. In order to effect a muting as regards the existing telephone connection or to maintain this telephone connection, the caller can operate the control field 28. In order to establish one or several telephone connections starting from his/her telephone in addition to the existing telephone connection, the control field “Conference call” indicated by 29 in FIG. 12 is provided.

In case the caller activates control field 28, the telephone connection established so far is maintained and muted, respectively, in order to enable the caller to initiate the establishment of a further telephone connection. Here, it is possible that in response to an operation of the control field 28, which can, for example, have a blue colour, the caller is informed via the maintained telephone connection that the caller wants to have the telephone connection established. For example, this can be obtained by means of a suitable voice reproduction (“please maintain connection”) and/or by means of playing music. In place of an operation of the control field 28, this condition can also be obtained in that the caller indicates that he/she wants to telephone with a further person after having operated the control field 12 (see FIG. 4) or using an address entry as set forth above with reference to the person to be called so far.

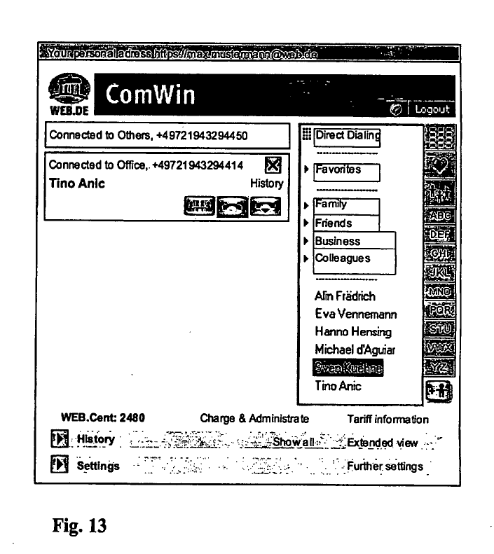

The case, in which the caller just wants to maintain the telephone connection established so far, is indicated in FIG. 13 in that in the address entries one thereof is marked (grey-shaded), which characterises the caller (“Baumgarten, Sven”). Further, it is contemplated that this condition is displayed by means of a corresponding, for example blue, colouring of the contact window. Also, a corresponding text display in window 24 (e. g. “Connected . . . [naming the telephone number of the caller telephone]”, “muted”) and/or in the status window 27 (“Connected to others”) can be used for visually indicating this condition.

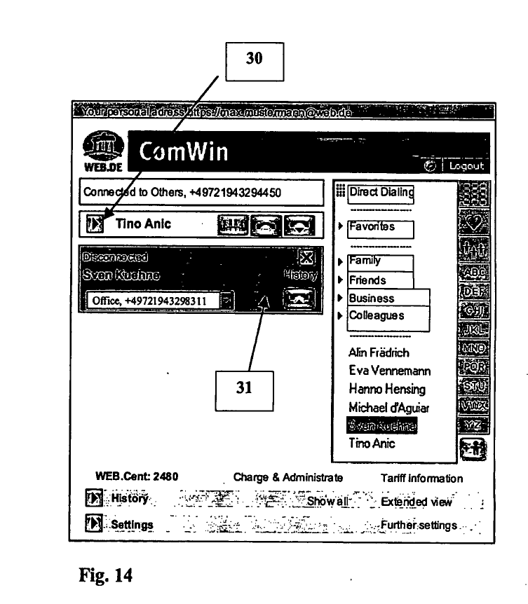

In a case, the caller wants to establish a further telephone connection using a telephone entry, the caller is provided the presentation to be seen in FIG. 14. Here, the contact window 24 associated to the first called person to which the telephone connection is maintained is presented in a changed manner as illustrated in FIG. 14. Here, the contact window 24 comprises a control field 30, an operation of which results that the telephone connection to the first person to be called does not remain muted, but can be used to telephone in conventional manner. I. e. by means of the control field 30, the caller can change between different telephone connections.

Further, as illustrated in FIG. 14, a further contact window 31 is used, which is associated to the person to be called now. The establishment of a telephone connection to a further person to be called is carried out as described above with reference to the first person to be called, wherein the observations given with respect to contact window 24 correspondingly apply to contact window 31. This is illustrated in FIG. 13 to 17.

In order to change between the two telephone connections now being established, beside the above described control field 30, the control field 28 or a control field 32 providing the functions thereof can be used.

For a conference call, i. e. a telephone connection simultaneously with several persons, the caller operates control field 29 (see FIG. 12). In response thereof, a window 33 is presented, in which a control field 34 comparable to the control field 26 in the embodiment illustrated in FIG. 10 serves for termination of a conference call being established as described below. A control field 35 in conference window 33 serves, comparable to control field 28 and 32, to effect a muting or maintenance of telephone connections but here as regards all telephone connections involved in a conference call.

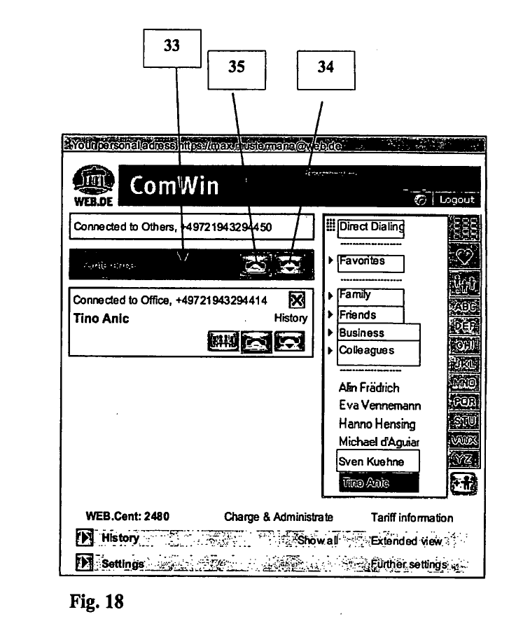

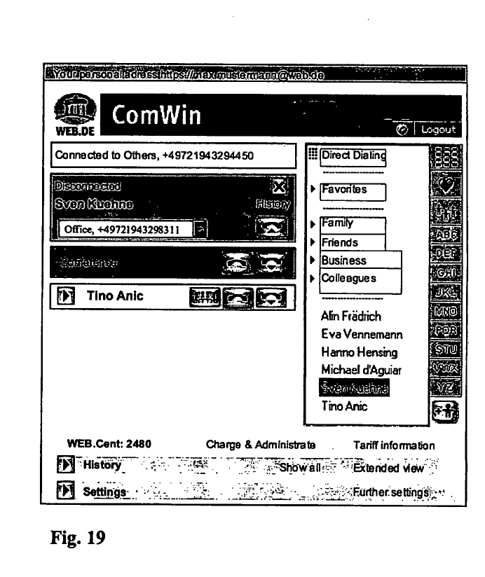

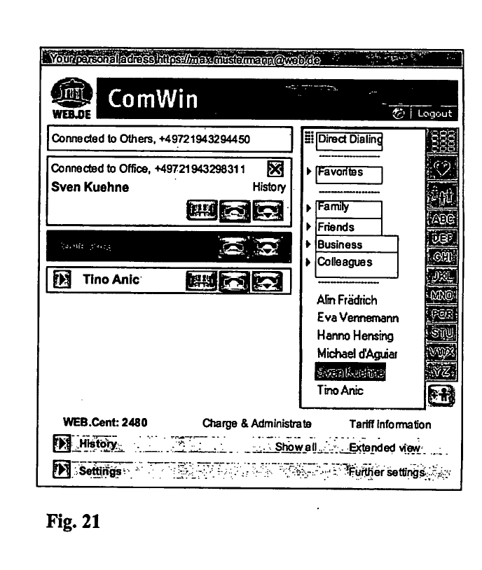

In the situation illustrated in FIG. 18, the caller has indicated that he/she wants to establish a conference call, wherein only the telephone connection established to the first called person is existing. The establishment of a telephone connection to a telephone of a further person who shall be involved in the conference call is accomplished as described above. This is illustrated in FIGS. 19 to 21. The web page illustrated in FIG. 21 indicates the condition, in which a telephone connection to a further person in established but no conference call is existing.

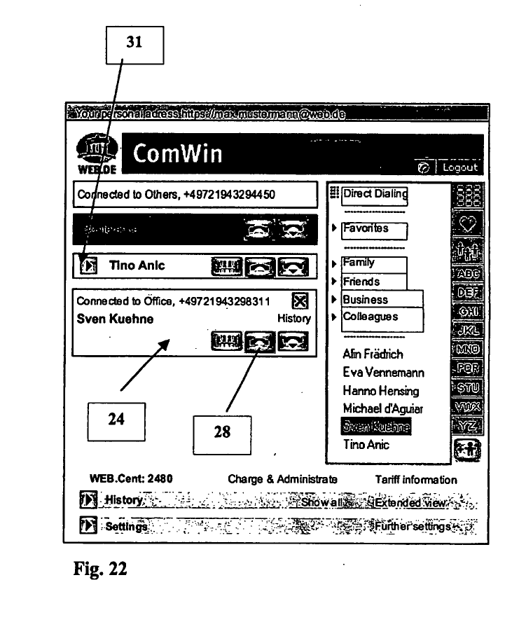

The actual conference call is obtained under control of the telecommunications web page in that the telephone connections to the two person to be called, which are separated so far, are coupled/connected with each other such that both the caller and also both called persons can telephone with each other. This condition is indicated to the caller in the web page illustrated in FIG. 22, in which the contact windows 24 and 31 are arranged below the conference window 33.

In order to “unite” one of the called participants in the framework of a conference call, the caller operates either the control field 28 or the control field 32. Advanced just see a contact window, which is associated to the call participant the telephone connection of which is to be united, is presented in a colourwisely changed manner, for example blue.

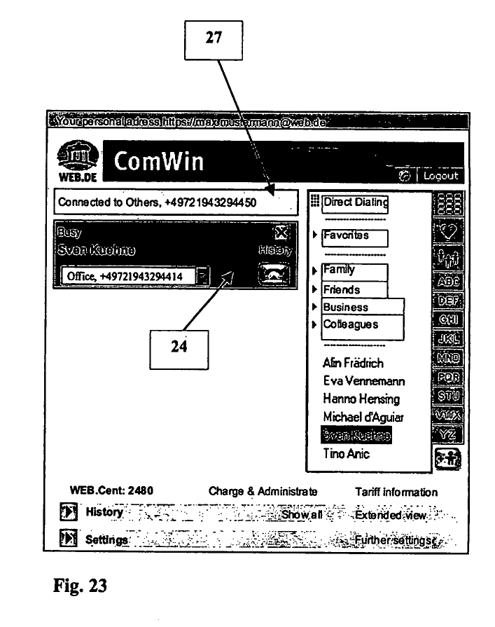

In case it is not possible to establish a telephone connection to a desired call a partner by means of the telecommunications web site, this can be indicated, as illustrated in FIG. 23 by means of the contract window 24. This can be obtained, for example, by display of a suitable text (line occupied) and/or by means of a suitable colourwise design, which also can change the name-cally (“blinking contact window”) also, a text display and/or colour design of the status window 27 suitable for that purpose is contemplated.

1-19. (canceled)

20. Method for telephoning, wherein a telephone connection is established between at least two telephones under control of a website.
